(19) United States
(12) Patent Application Publication
(10) Pub. No.: US 2026/0063483 A1
(43) Pub. Date: Mar. 5, 2026

(54) Systems and Methods of Non-Contact Force Sensing

(71) Applicant: The Regents of the University of California, Oakland, CA (US)

(72) Inventors: Yang Zhang, Los Angeles, CA (US); Siyou Pei, Oakland, CA (US); Pradyumna Chari, Los Angeles, CA (US); Xue Wang, Oakland, CA (US); Xiaoying Yang, Los Angeles, CA (US); Achuta Kadambi, Los Angeles, CA (US)

(73) Assignee: The Regents of the University of California, Oakland, CA (US)

(21) Appl. No.: 19/100,521

(22) PCT Filed: Jul. 28, 2023
(86) PCT No.: PCT/US2023/071190

§ 371 Date: Jan. 31, 2025

Related U.S. Application Data
(60) Provisional application No. 63/370,159, filed on Aug. 2, 2022.

(51) Int. Cl. G01L 1/24; G02B 27/48

(52) U.S. Cl. CPC G01L 1/24; G02B 27/48

(57) ABSTRACT

Systems and methods of non-contact force sensing are described. An embodiment includes a non-contact force sensing system, that includes: a laser source that illuminates a surface with a laser; a camera that captures video that includes several images of the surface; a process that includes: analyzing the images of the video to determine laser speckle motion due to surface deformations to the surface; and determining an applied force on the surface based on the analysis.

### CROSS REFERENCE TO RELATED APPLICATIONS

This application claims benefit of and priority under 35 U.S.C. 119(e) to U.S. Provisional Patent Application No. 63/370,159 entitled “Non-Contact Force Sensing” by Zhang et al., filed Aug. 2, 2022, the disclosure of which is hereby incorporated by reference in its entirety for all purposes.

### FIELD OF THE INVENTION

The present invention generally relates to non-contact force sensing systems that use laser speckle imaging to sense an applied force to an object surface based on deformations at the presence of force. In particular, systems in accordance with many embodiments can detect observable and discernable laser speckle shifts that can be leveraged to sense an applied force.

### BACKGROUND

Force is a ubiquitous signal that occurs when objects are in contact. As a side product of human activities and events in the environments, force can reveal unique information. Force sensing can be used in a wide range of ubiquitous computing and human-computer interaction. For example, touch interactions such as discrete button touches, swipes, and scrolling induce force between user' fingers and interaction mediums (e.g., buttons, glass panels, skin). Robots rely on force as critical information in the feedback loop for object manipulations. Moreover, force can derive a rich set of second-order signals. For example, force applied to host surfaces by objects on top reveals their weights. Force between users' fingers touch and contact surfaces reveals user intent. These signals can constitute rich information that intelligent sensing systems in real-world applications can leverage as a new channel of information in addition to other sensing modalities, including RGB and depth to become more robust, accurate, and privacy-preserving.

Normal force has a unit of Newton or N, and is the most common type in everyday environments. To sense this force, conventional approaches use instrument sensors (e.g., Force Sensitive Resistor) on surfaces, in between objects. This contact-based sensing approach may require wiring which can be inflexible to deploy, and/or runs on battery-powered wireless-enabled embedded systems which can be costly to scale. Additionally, contact-based sensors may be sensitive to exposure of elements, to address which the hardening process would make the sensor more expensive, and/or exchanging and maintaining these sensors could further increase labor cost.

### SUMMARY OF THE INVENTION

Non-contact force sensing systems that use laser speckle imaging to sense an applied force to an object surface based on deformations at the presence of force are described. An embodiment includes a non-contact force sensing system, that includes: a laser source that illuminates a surface with a laser; a camera that captures video including several images of the surface; a set of one or more processors; a non-transitory machine readable medium containing processor instructions for non-contact force sensing, where execution of the instructions by the set of processors causes the set of processors to perform a process that includes: analyzing the several images of the video to determine laser speckle motion due to surface deformations to the surface; and determining an applied force on the surface based on the analysis.

In a further embodiment, the laser source is in at least one mode selected from the group consisting of a diffused mode and a focused mode, wherein in the diffused mode, the laser source is diverged and expanded with multiple concave lens and an optical diffusing glass that can spread light over a surface, wherein in the focused mode, the laser remains as a bright dot with concentrated energy.

In a further embodiment, execution of the instructions by the set of processors causes the set of processors to perform a process that further includes analyzing the several images of the video to estimate flow displacement across fixed timeframes to obtain a correlated metric to flow velocity, where the flow displacement is converted to the flow velocity through a framerate-dependent scale factor.

In a further embodiment, execution of the instructions by the set of processors causes the set of processors to perform a process that further includes: calculating distance of laser speckle shifts between adjacent images of the several image as a laser speckle velocity (LSV), where the laser speckle shifts define a speckle motion; compute an integral of LSV (ILSV) as an indicator signal; and calculate an applied force f using the ILSV.

In a further embodiment, execution of the instructions by the set of processors causes the set of processors to perform a process that further includes: calculating an applied force f based on linearly correlating a speckle motion δI with the force f.

In a further embodiment, execution of the instructions by the set of processors causes the set of processors to perform a process that further includes: calculating an applied force f based on a distance D from the surface to the camera.

In a further embodiment, execution of the instructions by the set of processors causes the set of processors to perform a process that further includes: calculating an applied force based on a second moment of area

$$I = \frac{{wh}^{3}}{12} ,$$

where w and h are a width and thickness of a plate material, and the speckle motion δI is proportional to an inverse of a cube of thickness h.

In a further embodiment, execution of the instructions by the set of processors causes the set of processors to perform a process that further includes: determining a stiffness of the surface based on the laser speckle motion.

In a further embodiment, the surface is a type of surface from several different types of surfaces such that for a particular surface with a particular physical configuration, there is a mapping that is learned from an estimated average speckle velocity to an instantaneous applied surface pressure, where the speckle velocity estimate is an average projected length of vectors within an image frame towards an estimated center, for a given time frame that provides a signed measure for velocity, where a cumulative sum of the estimated velocity over time is directly related to an instantaneous applied force.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a speckle pattern of a 532 nm laser on a white wall (left) and simulated speckle pattern (right) in accordance with an embodiment of the invention.

FIG. 2 illustrates a deformation model in accordance with an embodiment of the invention.

FIG. 3 illustrates speckle motion due to plate deformation at the presence of force in accordance with an embodiment of the invention.

FIG. 4 illustrates speckle imaging with a defocused camera in accordance with an embodiment of the invention.

FIG. 5 illustrates a linear actuator setup in accordance with an embodiment of the invention.

FIG. 6 illustrates maps of integrated laser speckle velocity in presence of different amounts of force in accordance with an embodiment of the invention.

FIG. 7 illustrates a non-contact force sensing system sensor bundle in accordance with an embodiment of the invention.

FIG. 8 illustrates a process for speckle velocity field estimation in accordance with an embodiment of the invention.

FIG. 9 illustrates a process for real-time force estimation model training in accordance with some embodiments of the invention.

FIG. 10 illustrates on-world true-force touch sensing in accordance with an embodiment of the invention.

FIG. 11 illustrates interactive 3D prints using embedded non-contact force sensing systems in accordance with various embodiments of the invention.

FIG. 12 illustrates a distinctive set of regression models for different materials/object which can be leveraged for identification in accordance with an embodiment of the invention.

FIG. 13 illustrates remote force sensing for delicate object handing in accordance with an embodiment of the invention.

FIG. 14 illustrates a process of non-contact force sensing in accordance with an embodiment of the invention.

FIG. 15 illustrates a non-contact force sensing system architecture in accordance with an embodiment of the invention.

### DETAILED DESCRIPTION OF THE DRAWINGS

Turning now to the drawings, systems and methods for non-contact force sensing in accordance with embodiments of the invention are described. Non-contact force sensing systems in accordance with many embodiments of the invention may consider normal force, applied to objects in contact perpendicular to the contacting surfaces. Many of the inborn challenges of contact-based pressure sensors can eliminate sensing opportunities for a wide range of low-cost and passive objects such as 3D prints and/or room utilities (e.g., walls, tables, faucets, among others). Furthermore, there can also be scenarios where contact-based sensors might not be preferable, such as on-body interactions, from a user experience perspective.

Non-contact force sensing systems in accordance with many embodiments can detect and sense force based on laser speckle imaging. Non-contact force sensing systems in accordance with many embodiments can use laser speckle imaging to enable non-contact sensing for ubiquitous force signals. Accordingly, non-contact force sensing systems in accordance with many embodiments can be used within various different interactive systems. In particular, non-contact force sensing systems in accordance with many embodiments can detect minute deformations of surfaces when force is present using laser speckle imaging. In particular, laser speckles can change significantly at surface deformations even with very small magnitude. This can be because laser speckles can be caused by scattered signals added coherently, surface deformations of a same order of magnitude as a laser wavelength (e.g., several hundred nanometers) can alter laser speckles (where scattered signals add constructively and destructively based on their relative phases) significantly. During the course of surface deformations, the changes of laser speckles can have structured spatial and temporal patterns that can correlate with an amount of force applied. Sensor systems can analyze images captured from a camera to determine laser speckle motion due to surface deformations a surface and based on this analysis, determine an applied force to the surface. Many embodiments can estimate flow displacement across fixed timeframes to obtain a correlated metric to flow velocity, where the flow displacement is converted to the flow velocity through a framerate-dependent scale factor. Sensor systems can calculate distance of laser speckle shifts between adjacent images of a video as a laser speckle velocity (LSV), where the laser speckle shifts define a speckle motion and can compute an integral of LSV (ILSV) as an indicator signal, and thereby can calculate an applied force f using the ILSV.

In many embodiments, there can be different mappings between force and surface deformations based on the type of surface, and this mapping can be learned from an estimated average speckle velocity to an instantaneous applied surface pressure, where the speckle velocity estimate is an average projected length of vectors within an image frame towards an estimated center, for a given time frame that provides a signed measure for velocity, wherein a cumulative sum of the estimated velocity over time is directly related to an instantaneous applied force.

Non-contact force sensing systems in accordance with many embodiments can include core signal-processing processes that include speckle denoising, optic flow displacement tracking, and/or denoised aggregation among various other processes. Non-contact force sensing systems in accordance with many embodiments can utilizes different sensing configurations, including diffused and/or focused laser, among other sensing configurations as appropriate to the requirements of specific applications in accordance with embodiments of the invention. In certain embodiments, two (or more) laser divergence configurations can include diverged laser beams to cover a wide surface area where force could happen, and/or focused (not diverged) laser beams to sense force that may have a deterministic location. Non-contact force sensing systems in accordance with many embodiments provide an end-to-end system including hardware and/or software to sense force in a non-contact manner based on laser speckle imaging.

### Modeling Laser Speckle

### Laser Speckle Pattern on Rough Surfaces

When rough surfaces are illuminated by a laser beam, a random interference pattern can be observed in the image plane, called laser speckle. A whole diffuse surface can be regarded as being composed of massive independent scattering surface elements. Since most surfaces elements irradiated by a laser beam can be sufficiently rough compared to the scale of the laser wavelength, they can produce statistically independent phases of waves that apply to the incident light. Light transmitted and/or reflected by different surface elements traverses to the observation plane and may interfere when they meet in space, thus each pixel in the image plane would receive contributions from multiple reflected lights and form granular structures with random distribution, called laser speckle.

Simulations can be run to verify this understanding of laser speckles. To simulate laser beams, a Gaussian beam can be used as the incident light over a uniform random rough surface Φ(x′, y′). Beam distribution g(x′, y′, z) on the rough surface with distance z between the origin to the surface can be evaluated as provided by equation 1.

$$g ( {x}^{′} , {y}^{′} , {z}^{′} ) = \frac{{ω}_{0}}{ω} {e}^{[ - ( x {′}^{2} + y {′}^{2} ) ( \frac{1}{{ω}^{2}} + \frac{ik}{2 ρ} ) - ikz ]} \qquad ( 1 )$$

ω₀ and ω are the waist radius, and illuminated beam spot radius, respectively. λ is the wavelength of Gaussian beam with

$$k = \frac{2 π}{λ} ,$$

and ρ means the wave-front curvature radius. The back-scattered light transmitting to the observation plane (x,y) can be modeled by the Fresnel diffraction.

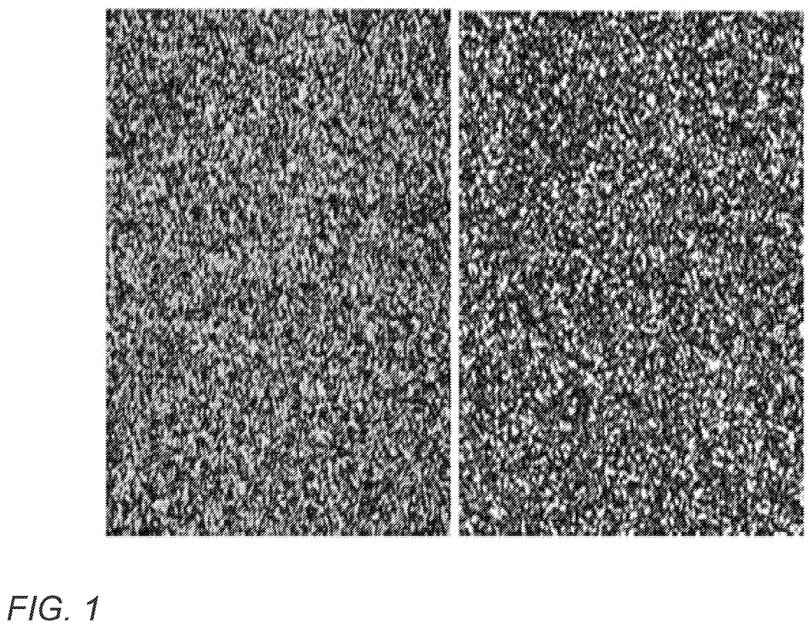

To validate a simulation, real-world laser speckle can be collected on a white wall using a camera (e.g., USB camera of 2592×1944 pixels resolution). The laser speckle can be induced by a laser (e.g., 10 mW 532 nm green laser) with a particular divergence (e.g., 12-degree divergence), positioned a particular distance (e.g., 10 cm) away from the wall. A real-world speckle and simulation speckle pattern in accordance with an embodiment of the invention is illustrated in FIG. 1. In particular, FIG. 1 illustrates a speckle pattern of 532 nm laser on a white wall (left) and simulated speckle pattern (right) in accordance with an embodiment of the invention.

With the subtle deformation of the object surface, each speckle on the speckle pattern can shift intact in some directions, which means the speckle patterns of adjacent moments can have high similarity. However, the speckle patterns can also boil, meaning the original spatial structure of patterns has been altered and the speckles tumble randomly fading in and out. In general, speckle motion can appear as a combination of speckle translation and boiling since the speckle deformation may occur inevitably. As provided by equation (2) below, the evaluation factor E can numerically signify the dominant speckle motion type by the relationship between the translation distance X_{T} and the average grain size of dynamic speckle Rₛ: if |ε|>1, that means the speckle change is more about translating rather than boiling. Non-contact force sensing systems in accordance with many embodiments of the invention can leverage these signals. To compensate for the boiling effect, as described in detail below, non-contact force sensing systems in accordance with many embodiments can utilize one or more processes so that spatial continuity may not be a prerequisite (e.g., tracking the same set of speckles over long distances on images).

$$ε = {X}_{T} / {R}_{s} \qquad ( 2 )$$

### Laser Speckle Motion Due to Surface Deformation

Non-contact force sensing systems in accordance with many embodiments can use information regarding theoretical speckle flow models that can explain how a laser speckle pattern changes on an image sensor plane due to deformations in the presence of force.

### Deformation Model

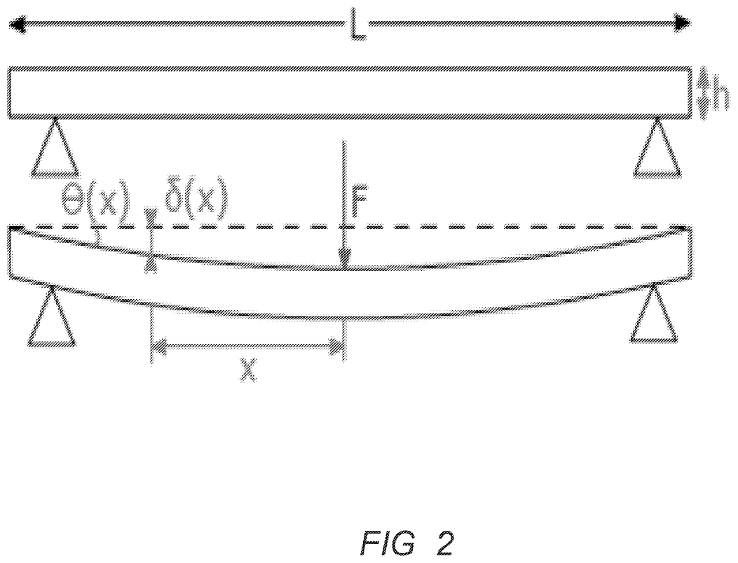

For simplicity of exposition, without loss of generality, we frame the physical model of touching a surface as applying a concentrated load to the center of a rectangular plate with edges simply supported. Assuming the plate is isotropic and homogeneous, we can simplify the problem by looking at its transverse cross-section, which is a beam. As shown in FIG. 2 in accordance with an embodiment of the invention, f is the point load, x is the distance from center to a point of interest, δ(x,f) is the plate deflection at x, δₘₐₓ is the deflection maximum which locates at the plate center, θ(x,f) is the angle of deformed plate at x in radians. The θ is defined as 0 when the plate is not deformed. An increasing force may be followed by a proportionally growing deformation deflection. Their quantitative relationship is described in the expression (3), where E is the Young's Modulus, I is the Second Moment of Area, L is the scale of plate.

$$δ ( x , f ) = \frac{f}{48 EI} ( {L}^{3} - 6 {Lx}^{2} + 4 {x}^{3} ) 0 \leq x \leq L / 2 \qquad ( 3 )$$

When x=0 we have,

$${δ}_{max} = \frac{{fL}^{3}}{48 EI} \qquad ( 4 )$$

The angle is given by,

$$θ ( x , f ) = \frac{f}{4 EI} ( Lx - {x}^{2} ) 0 \leq x \leq L / 2 \qquad ( 5 )$$

The maximum angle is obtained at the edge

$${θ}_{max} = \frac{{fL}^{2}}{16 EI} \qquad ( 6 )$$

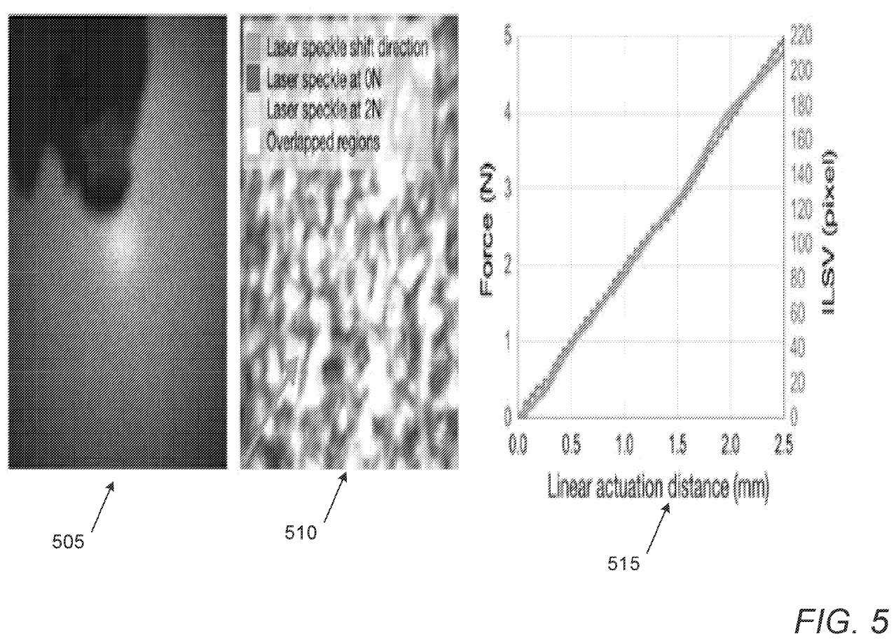

It is straightforward from the formula that the deformation distance can scale linearly with the magnitude of force applied. This can be verified in signal validation, as illustrated in FIG. 5, right in accordance with an embodiment of the invention. Although FIG. 2 illustrates a particular deformation model that frames a physical model of touching a surface as applying a concentrated load to a center of a rectangular plate with edges simply supported, any of a variety of models can be utilized as appropriate to the requirements of specific applications in accordance with embodiments of the invention.

### Micro-Surface Hypothesis

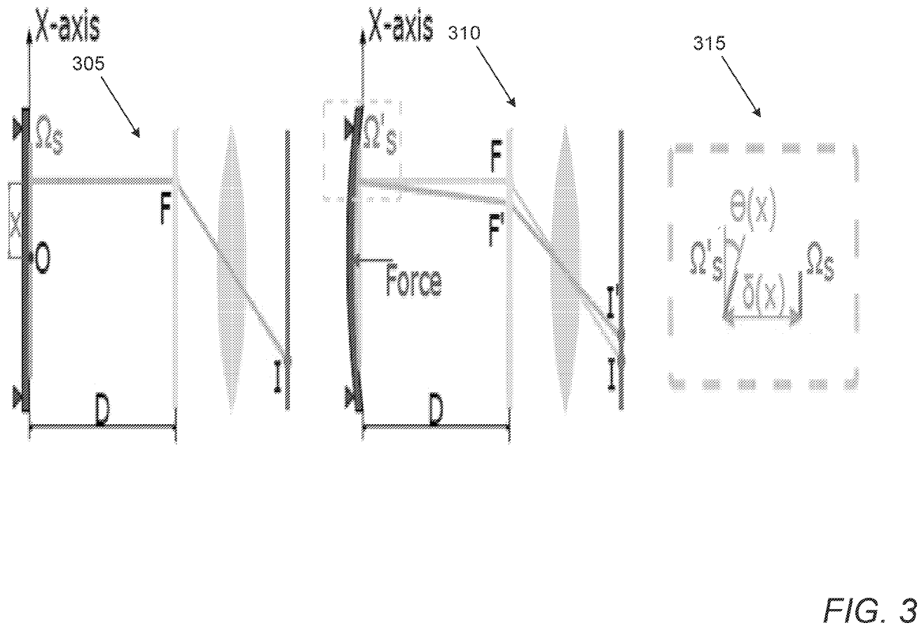

In many embodiments, the following hypothesis may be used to approximate a surface for a sensing principle. A surface can be divided into multiple small sub-surfaces as illustrated in FIG. 3 in accordance with an embodiment of invention. When a sub-surface is small enough, its area can become insignificant for our interest. We define such a sub-surface a micro-surface. If we look from the side, the plate surface is a polygonal line combining line segments of all micro-surfaces. The line length of each micro-surface may be too small to be significant.

As shown in FIG. 3 in accordance with an embodiment of the invention, in 2D space, we describe the location, deflection distance and angle of a micro-surface respectively with x (distance from plate center to the micro-surface), δ, and θ. In 3D space, we can specify these with 3D coordinates and normal vectors. Proof in 3D space can be a symmetry-based extension of the discussion in 2D space. Considering a deformation model can be isotropic on the homogeneous plate, we will move on to proof in 2D space to make it concise and clear.

FIG. 3 illustrates speckle motion and micro-surface representation; left 305: no force; center 310: speckle motion due to force applied; right 315: micro-surface in 2D space in accordance with an embodiment of the invention. Although FIG. 3 illustrate a particular surface and speckle motion due to plate deformation at the presence of force, any of a variety of surface and speckle motion models can be utilized as appropriate for the requirements of particular applications in accordance with embodiments of the invention.

### Speckle Motion Due to Surface Deformation

Statement: A speckle motion goes towards the contact center at the presence of force. The motion displacement on the image plate can be described by

$$Δ I = aD \frac{{f}_{0}}{4 EI} ( Lx - {x}^{2} ) 0 \leq x \leq L / 2 \qquad ( 7 )$$

where a is a scaling factor of focal-image projection model, D is the focal-surface distance, f₀ is the actuated force, L is the surface length, x is the Ω_{S}−0 distance.

### Configurations

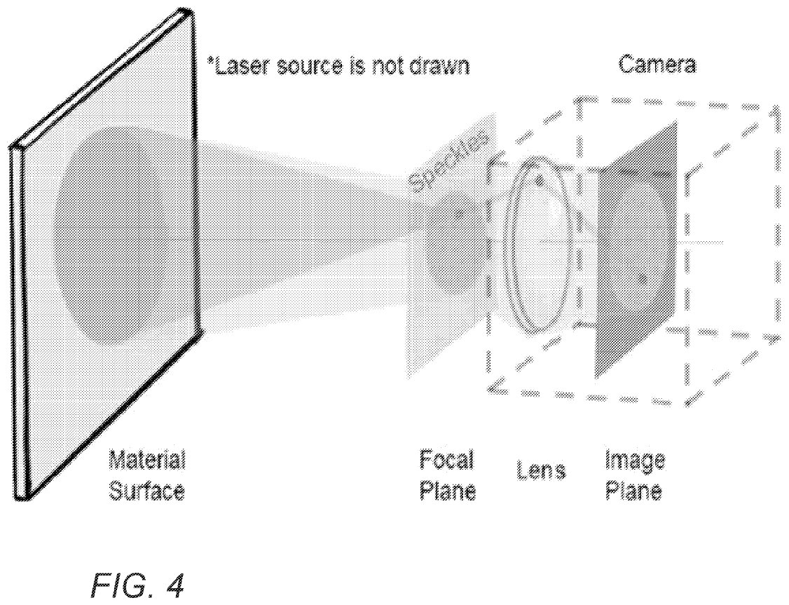

Non-contact force sensing systems can include one or more different cameras, lens, and processing configurations as appropriate to the requirements of specific applications. A non-contact force sensing with speckle imaging system with a defocused camera in accordance with an embodiment of the invention is illustrated in FIG. 4. As illustrated, a material surface can be shined by a laser beam and can generate speckles. The speckles can be captured by a camera which can be set to particular mode (e.g., defocused mode) by drawing the focus plane closer to the lens. As shown in FIG. 4, a configuration of a model can include a laser source, a surface, and a camera with a focus lens, its focal plane and imaging sensor plate. The camera can be under defocused mode as its focus plane is close to the lens rather than on the surface, leading to blurry imaging. The speckles can be captured by the defocused camera. As shown in FIG. 3, the origin of the coordinate system can be configured at the initial center of the plate O, the intersection of the plate and the optical axis through the center of the lens. The original surface plane is D m away from the focal plane. Although FIG. 4 illustrates a particular configuration of a non-contact force sensing system with speckle imaging with a defocused camera, any of variety of configurations, including different types of lasers, cameras, surfaces, modes, focal plans, and/or imaging sensor plates can be utilized as appropriate to the requirements of specific applications in accordance with embodiments of the invention.

### Proof:

Suppose we have a micro-surface Ω_{S} which is x away from the origin O, reflecting light rays of the laser source onto the lens through a focus point F. With no external force, its deflection displacement δ(x,f)|_{F=0}=0 and deformation angle θ(x,f)|_{F=0}=0. The focus point F, acting as a new light source to the lens, has a conjugate point of pixel I on the sensor plane. Then, a small force is applied at the surface center and pushes the micro-surface Ω_{S} all the way to Ω_{S}, with deflection

$$δ ( x , f ) {\vert}_{f = {f}_{0}} = \frac{{f}_{0}}{48 EI} ( {L}^{3} - 6 {Lx}^{2} + 4 {x}^{3} ) \qquad ( 8 )$$

and deformation angle

$$θ ( x , f ) {\vert}_{f = {f}_{0}} = \frac{{f}_{0}}{4 EI} ( Lx - {x}^{2} ) \qquad ( 9 )$$

The focus point F shifts to F′ accordingly on the focus plane. Therefore, the conjugate point I moves to I′, toward the center.

We can model the speckle motion as below

$$Δ I = a Δ F = a \vert {F}^{′} - F \vert = a ( D + δ ( x , {f}_{0} ) ) tan θ ( x , {f}_{0} ) \qquad ( 10 )$$

where a is the scaling factor of the projection model between the focal plane and the imaging plane.

In certain embodiments, the D (m) can be much larger than the surface deformation (from nm to mm), the modeling can be approximated as

$$Δ I = aD tan θ ( x , f ) = aD \frac{{f}_{0}}{4 EI} ( Lx - {x}^{2} ) \qquad ( 11 )$$

From the speckle motion model, we can draw several conclusions, which match observations in experiments:

1. The speckle motion δI is linearly correlated with force f.

2. The speckle motion δI grows as the distance D from surface to the camera increases.

3. The second moment of area

$$I = \frac{{wh}^{3}}{12} ,$$

where w and h are the width and thickness of the plate material, the speckle motion δI is proportional to the inverse of the cube of thickness h.

4. When the stiffness increases (the Young's Modulus E is larger), the speckle motion δI decreases.

### Signal Validations

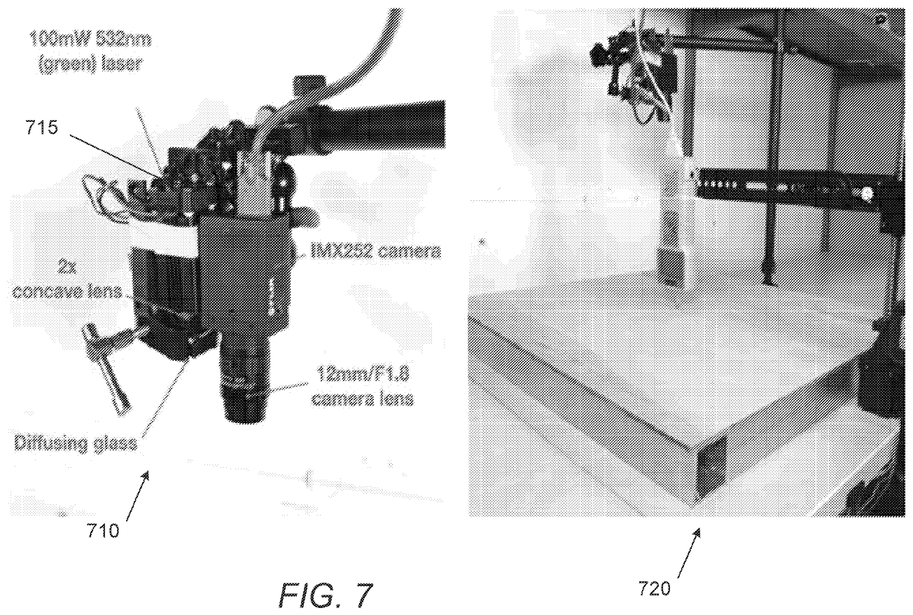

Data can be collected to verify sensing principles and modeling. A motor-based linear actuator can be used (see e.g., FIG. 7 right 720 in accordance with an embodiment of the invention) to actuate a 50 cm square metal surface which measured

$$1.59 mm ( {\frac{1}{16}}^{″} )$$

thick. Surface deformation can be measured by counting motor steps (at 0.78 Âμm resolution) while the applied force was measured with the force meter affixed to the linear actuator's end effector. Non-contact force sensing systems in accordance with many embodiments can bundle a camera (e.g., GS3-U3-32S4M-C 1/1.8″ FLIR Grasshopper® 3, with 1536×2048 pixel resolution at 121 FPS) with a laser (e.g., a diffused 100 mW 532 nm green laser with divergence fan angle=79.6 degrees). Non-contact force sensing systems in accordance with many embodiments can use a band-pass optical filter (e.g., 532 nm band-pass optical filter) placed in front of a camera, and a sensor bundle can be placed above a linear actuator. The linear actuator can be controlled to advance until a measured force (e.g., 5 Newtons of force was measured). Data from one or more sensors can be streamed to a computer (e.g., PC) through a communication interface and/or connection (e.g., USB connections).

A linear actuator setup for validation of sensing principals in accordance with an embodiment of the invention is illustrated in FIG. 5. As illustrated, FIG. 5 left 505 illustrates laser speckle captured by a camera with a band-pass optical filter; FIG. 5 center 510 illustrates speckle shift due to surface deformations caused by the applied force; and FIG. 5 right 515 illustrates an integrated laser speckle shift correlates with the applied force in accordance with an embodiment of the invention. Furthermore, FIG. 5 center 510 shows distinctive and recognizable laser shifts at 10 cm from the point of the applied force (0 N vs. 2 N). The laser can be focused in the collection to avoid quantization in images when zoomed in. These shifts were due to small surface deformations caused by the applied force and the speed of which correlates with the force applied to the surface. Many embodiments can use optical flow to calculate the distance of laser speckle shift between adjacent frames as laser speckle velocity (LSV). Note that LSV can be referred to as the speckle motion in modeling. FIG. 5 right 515 illustrates a graph that plots ILSV and the applied force over linear actuation distance across the entire image frame excluding regions occluded by the sensor bundle. The two signals show a considerable level of correlation. This result provides verification of sensing principles. Non-contact systems in accordance with many embodiments can use an integral of LSV (ILSV) as an indicator signal to calculate an applied force.

### Calibration

Test surfaces in validation studies can be simplifications of real-world objects, which are often complex (e.g., uneven surfaces, irregular shapes, varying thicknesses, and heterogeneous material compositions, among other differences). Modeling this level of complexity can require precise sensory systems (e.g., 3D scanners) and calculation. In comparison, calibration can be a more viable path for its simple set up process so long as the signal has high repeatability and/or an algorithm can cope with shifts in signals over time and configuration changes. Calibration can be a common technique in Laser Speckle Imaging—for example, Laser Speckle Contrast Imaging may require that a baseline be captured to compare incoming frames with. Calibration can also be common in force sensing. For example, once FSR is inserted, calibration can be needed to map its resistance to an amount of applied force. Non-contact systems in accordance with many embodiments can be designed with an empirical approach, to develop processes and/or algorithms with minimal calibrations needed in practical force-sensing applications.

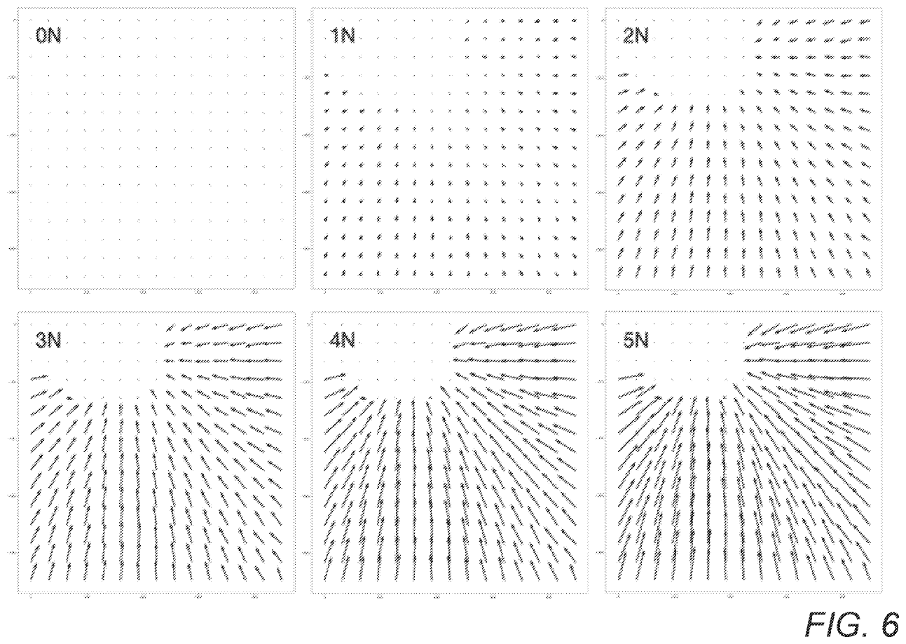

This investigation aims to identify variables needed for calibrations. This can be important knowledge to acquire, since it can decide the corresponding measurements to take place and interaction overheads needed on users' ends. To acquire this knowledge, certain embodiments can reuse data collected from previous test and plot out the ILSV in the presence of 0 N, 1 N, 2 N, 3 N, 4 N, and 5 N force respectively. FIG. 6 illustrates ILSV across a center region of 900×900 pixels. The length and direction of each quiver indicate the magnitude (normalized across the full image frame) and the direction of ILSV.

FIG. 6 illustrates various observations drawn from this result. In particular, there can be regional variances. FIG. 6 illustrates maps of Integrated Laser Speckle Velocity in presence of different amounts of force in accordance with an embodiment of the invention. As FIG. 6 shows, vectors ILSV can be affected by the distance (d) and the angle (θ) between the ROI and the force center. Also, while angular variance can show irregularity, the distance variance may show some linearity—specifically, the magnitude of ILSV can be linearly proportional to d. In other words, at any given angle, the magnitude of ILSV can increase with its distance to the force center. This result indicates that regions of interest of various sizes and locations can be used to build regression models in non-contact force sensing systems in accordance with many embodiments. However different ROIs can have different scaling factors which can be a function of distance and angle S=f(d,θ)—ROIs at different locations may need to be calibrated separately. Non-contact force sensing systems in accordance with many embodiments can provide location-variant calibration process in software and/or hardware once data is collected from a camera (e.g., a wide-area sensor among other types of sensors). Non-contact force sensing systems in accordance with many embodiments can utilize a minimal calibration process.

Implementations in Accordance with Many Embodiments

### Sensor Bundles

Non-contact force sensing systems in accordance with many embodiments can include a sensor that includes a camera and a point laser projector. A non-contact force sensing systems that includes a camera and a point laser projector in accordance with an embodiment of the invention is illustrated in FIG. 7. As illustrated in FIG. 7, left 710, the sensor can include a camera (e.g., GS3-U3-32S4M-C 1/1.8″ FLIR Grasshopper® 3 among other types of cameras) and a point laser projector 715. The green point laser projector 715 can have a particular wavelength (e.g., wavelength of 532 nm), and power (e.g., power of 100 mW). Non-contact force sensing systems in accordance with many embodiments can use a camera at a particular framerate (e.g., highest framerate of 121 fps) with a particular lens (e.g., fixed 4 mm/F1.8 lens) throughout the evaluation, with its working distance adjusted to a particular distance (e.g., 0 mm) such that the camera is out-of-focus. A particular camera filter (e.g., 532 nm camera filter) can be attached to the camera for better signals. The camera and the laser projector can be placed close to each other, pointing to the same direction. The camera can capture speckles from the diffuse reflection of the laser on an object surface. Although FIG. 7 illustrates a particular non-contact force sensing system that includes a particular camera and a laser configuration, any of a variety of camera and/or laser configurations can be utilized as appropriate to the requirements of specific applications in accordance with embodiments of the invention.

Non-contact force sensing systems in accordance with many embodiments can include two (or more) configurations for a laser in a sensor bundle, including a diffused mode and a focused mode. In a diffused mode, a laser can be diverged and expanded with multiple concave lens (e.g., two LD2568-A with −9.0 mm focal length and one LD2060-A with −15.0 mm focal length) and an optical diffusing glass so the green light can spread over a whole surface. In a focused mode, a laser can remain as a bright dot with concentrated energy there. Different laser configurations can be specified as appropriate to the requirements of specific applications in accordance with embodiments of the invention.

### Processes/Algorithms

An output of a sensor setup can be an ordered stack of video frames

$${\{ {v}^{k} \}}_{k = 0}^{N - 1} ,$$

where N is the total number of frames. Non-contact force sensing systems in accordance with many embodiments may set that a video be captured at a framerate f. Goals from this frame-stack can be twofold: first, reliable estimates for speckle velocity fields; and second, a real-time estimate for applied pressure. These aspects among others are discussed below.

### Speckle Velocity Fields

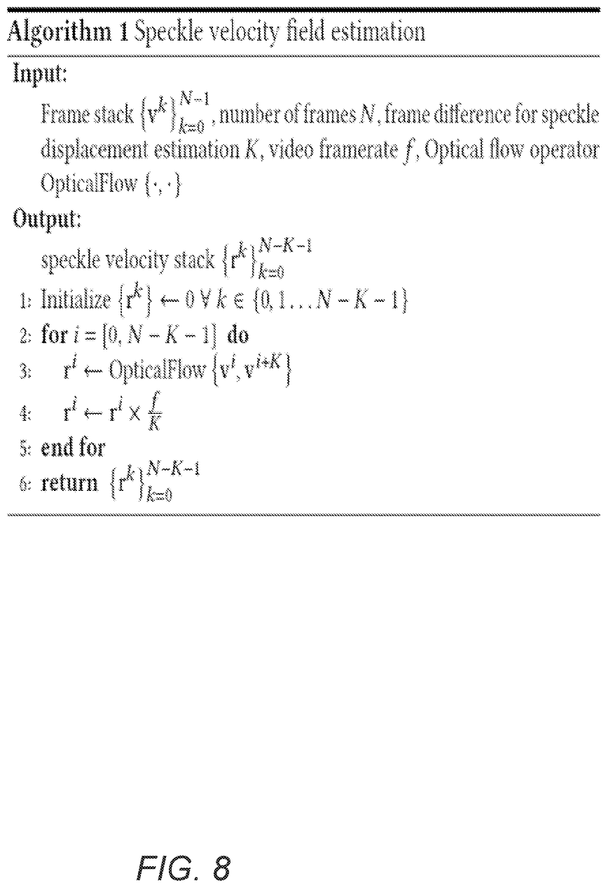

Speckle frames can have distinctive structure. Qualitatively, as a result of touch, the speckle patterns can show distinctive centripetal displacement. On smaller time-scales, these can be approximated as local pattern translations. However, across larger timeframes, scale differences may also be observed in local patterns. Given these observations, a velocity field estimation problem can be set up as a flow estimation problem across small timeframes. That is we estimate flow displacement across fixed timeframes, thereby obtaining a correlated metric to the flow velocity. The displacement flow can be converted to a velocity flow through a framerate-dependent scale factor. FIG. 8 illustrates a process that includes pseudocode for an algorithm for speckle velocity field estimation in accordance with an embodiment of the invention. In the evaluation, K can be set to 1, which means flow displacement is estimated across every two adjacent frames. Although FIG. 8 illustrates a particular process for speckle velocity field estimation, any of a variety of processes can be utilized as appropriate to the requirements of specific applications in accordance with embodiments of the invention.

### Real-Time Force Estimation

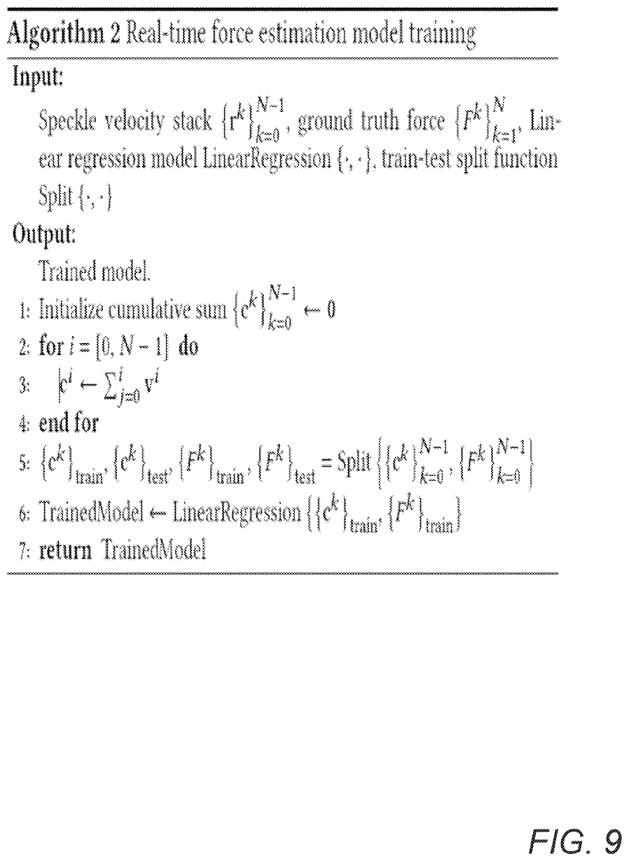

Qualitatively, an applied force on a surface and temporal integral of the speckle velocity can be directly correlated. Therefore, given an object surface of a given material, with a given physical configuration, a mapping may be learned from the estimated average speckle velocity to the instantaneous applied surface pressure. The speckle velocity estimate can be the average projected length of all vectors within the image frame, towards the estimated center, for a given time frame. Note that this gives us a signed measure for velocity. A cumulative sum of the estimated velocity over time can then be directly related to the instantaneous applied force. A linear regression framework can be setup to aid this prediction. Two or more regression calibration strategies can be utilized. A first strategy can be to split trials (e.g., five trials) into train trials and test trials with different split percentages. For example, the train-test split percentage is 1/(1+4)=20% when we build the regressor on one trial and test it on the other four trials. Different combinations under the same percentages can be grouped in an N-fold manner. A second calibration strategy can be to bucket ground-truth pressure measurements into different equal bins (e.g., five equal bins) within the same trial, split the bins into train bin(s) and test bin(s) with different split percentages. For example, a split percentage 40% indicates the regressor is built on forces in the first two bins and tested on the three remaining bins. In this calibration strategy, train portion can start from 0 N, and test portion can follow the end of train portion. We test the scenario that larger force can be predicted when the model is only trained on a smaller range of force data. FIG. 9 illustrates a process that provides pseudo-code for real-time force estimation model training in accordance with an embodiment of the invention. Although FIG. 9 illustrates a particular process for real-time force estimation model training, any of a variety of processes can be utilized as appropriate to the requirements of specific applications in accordance with embodiments of the invention.

### On-World Touch Sensing

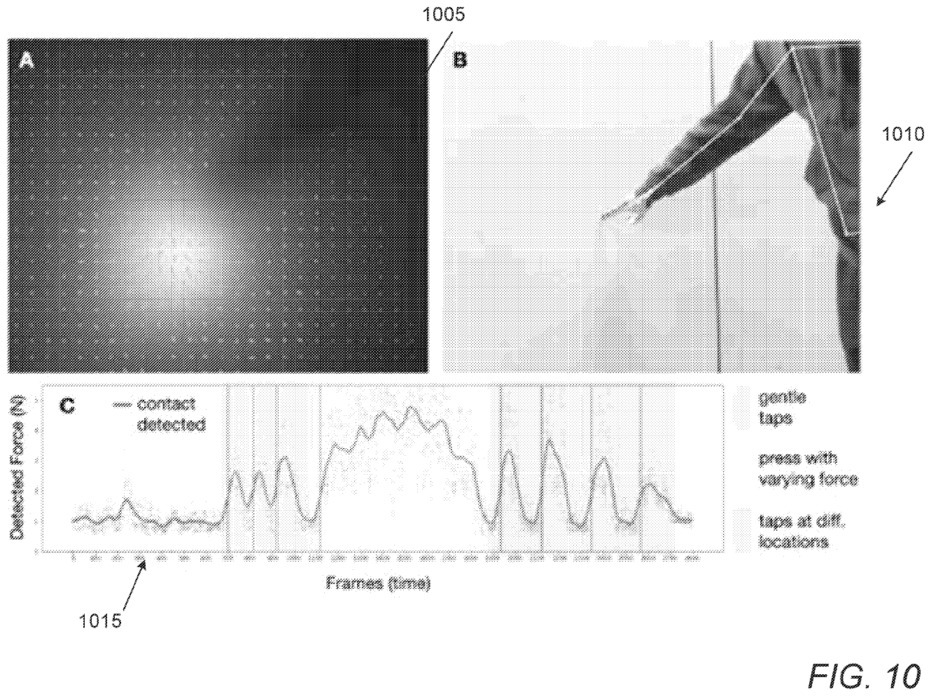

Projected touch interfaces can create a ubiquitous interaction experience. With depth cameras, touch sensing on everyday surfaces has been implemented. And yet, commodity depth cameras cannot sense fine-grain touch with small finger movements (sub-centimeter). However, being able to sense minute surface touches without users having to exaggerate their motions to accommodate for sensor inaccuracy can be critical to fully utilize the natural interactions provided by touch. In this regard, non-contact force sensing systems in accordance with many embodiments can use force as an additional signal to aid touch segmentation (e.g., touch vs. no touch). Integrated laser speckle velocity maps on office partitions when a user touches them at forces similar to ones on touchscreens in accordance with an embodiment of the invention is illustrated in FIG. 10. Many embodiments can use pose tracking (e.g., Google MediaPipe pose tracking) to exclude regions from users, resulting in a robust detection pipeline that is not interfered by user motions. Non-contact force sensing systems in accordance with many embodiments can be utilized for many everyday surfaces including, for example, a fabric couch arm, a wood table, walls, and a fridge door, among various other surfaces.

FIG. 10 illustrates on-world true-force touch sensing in accordance with an embodiment of the invention, including 1005 A: Integrated Laser Speckle Velocity overlaid on top of a speckle images captured by a camera; 1010 B: an RGB image captured by a webcam; and 1015 C: detected force from a non-contact force sensing system. In many embodiments, to avoid optical flows induced by user motions, sensing can be turned off at regions that are recognized as user body by pose tracking (e.g., MediaPipe pose tracking).

### 3D Printing Interactivity

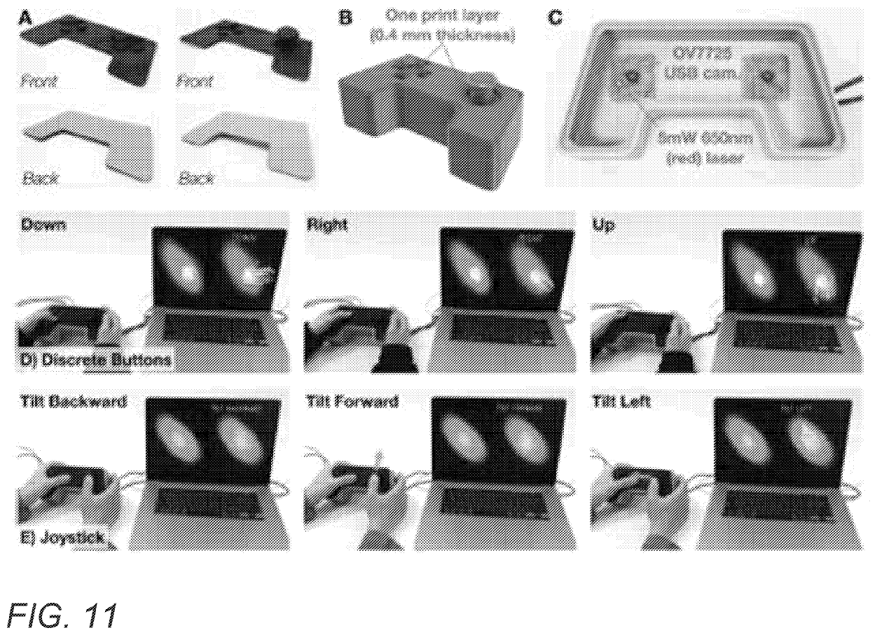

Non-contact force sensing systems in accordance with many embodiments can provide 3D printing interactivity. Non-contact force sensing systems in accordance with many embodiments can embed a laser (e.g., 3 mW laser) and a camera (e.g., low-end webcam). FIG. 11 illustrates a non-contact force sensing systems in accordance with several embodiments of the invention. In particular, FIG. 11 illustrates interactive 3D prints using embedded non-contact force sensing system in accordance with many embodiments systems. FIG. 11, item A illustrates two hand controller template designs that transform user interactions into bottom surface deformations with thin printed layer; item B illustrates 3D models of a hand controller; item C illustrates two non-contact force sensing systems made of only low-cost components that can be embedded inside a hand controller. FIG. 11 also illustrates live detection results of user interactions using discrete buttons and the joystick. Non-contact force sensing systems in accordance with many embodiments can sense surface deformations due to the applied force when users are interacting with the buttons and the joystick. Non-contact force sensing systems in accordance with many embodiments can observe discernable surface deformations when users press different buttons, and/or tilt a joystick in different directions. Non-contact force sensing systems in accordance with many embodiments can attach sensor bundles attached to a controller base, thus a user can easily switch controller top plates for applications that demand different interactivities.

### Force-Based Material/Object Identification

Material identification has shown practical uses in HCl, as prior works demonstrated ID-enabled interactions and material-aware laser cutting. Different types of materials can exhibit distinguishable surface deformations in response to force due to their differences in density and internal microstructures. For example, solid materials (e.g., wood) can deform more uniformly across the surface resulting in a wider and shallow “footprint” whereas soft materials (e.g., silicone) can deform locally around the force point resulting in a narrow and deep “footprint”. The geometry of these footprints can reveal information of its host material.

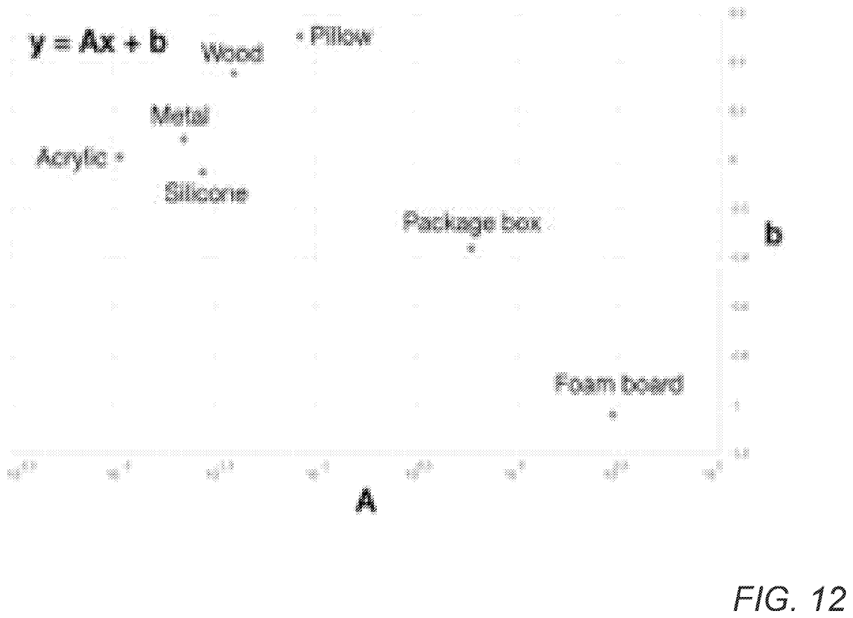

Non-contact force sensing systems in accordance with many embodiments can use parameters learned in building regression models from a calibration process as features for classifiers. FIG. 12 illustrates a graph that shows differences in parameters learned in a regression process which can be leveraged for identification in accordance with an embodiment of the invention.

Non-contact force sensing systems in accordance with many embodiments can use force-based material identification in various applications in digital fabrications (e.g., water jetting among others) as well as object handling with machines (e.g., robot arms can apply less amount of force when handling objects with delicate materials), among many other applications as appropriate to the requirements of specific applications.

### Force-Aware Object Manipulation

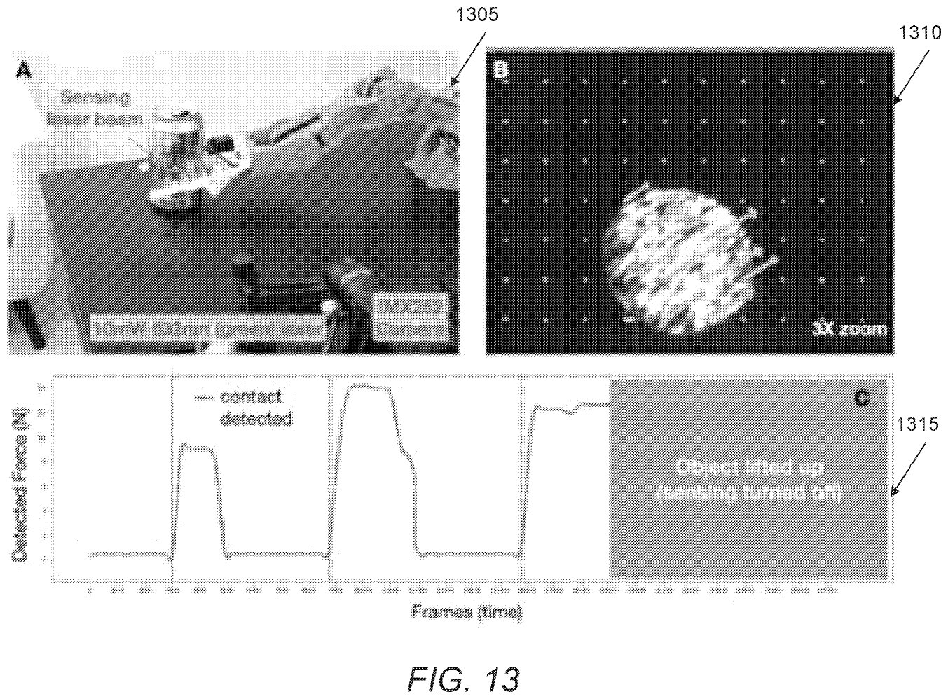

Non-contact force sensing systems in accordance with many embodiments can handle different objects (delicate vs. durable) using force-sensitive mechanisms. Conventional methods may rely on force sensors on robot arm. Non-contact force sensing systems in accordance with many embodiments can facilitate remote sensing, including using centralized sensing in which one or more sensors can sense force for multiple robot arms under a sensing field of view (e.g., similar to a sensing scheme of security cameras). A remote force sensing system for object handling with force-sensitivity in accordance with an embodiment of the invention is illustrated in FIG. 13. In particular, FIG. 13 item A 1305 illustrates a non-contact force sensing system working with a robot arm (e.g., Arduino Braccio), to sense a grasping force on an object (e.g., soda can) as a test primitive in accordance with an embodiment of the invention. A focused laser (e.g., 10 mW laser) can be used, as illustrated in item A 1305. In particular, FIG. 13 item A 1305 illustrates a robotic arm sequentially grasps a soda can with three different amounts of force—light, strong, and medium FIG. 13 item B 1310 illustrates an Integrated Laser Speckle Velocity (ILSV). Once a force reaches a desirable amount, a robot arm can start lifting up the object, as illustrated in FIG. 13 item C 1315 in accordance with an embodiment of the invention. Although FIG. 13 illustrates remote force sensing using a robotic arm, any of variety of remote force sensing applications can be implemented as appropriate to the requirements of specific applications in accordance with embodiments of the invention.

### Laser Safety

Non-contact force sensing systems in accordance with many embodiments of the invention can include different types of lasers with different strengths. Non-contact force sensing systems in accordance with many embodiments of the invention can use a strong laser (e.g., 100 mW, Class III B) which can be by itself hazardous for eye exposure. However, a laser can be used in diffused settings with a wide divergence angle achieved by using a particular lens structure (e.g., two concave lens concatenating with a diffusing glass). The diffusion can significantly shorten the Nominal Ocular Hazard Distance (NOHD). At a divergence (e.g., 79.6 degrees), the NOHD can be 5.09 cm. To improve the safety of users, non-contact force sensing systems in accordance with many embodiments of the invention can include other sensing modalities, including RGB cameras and/or depth sensing among many other types of sensing modalities as appropriate to the requirements of specific applications. Non-contact force sensing systems in accordance with many embodiments of the invention can turn off a laser once users are within a certain distance. Non-contact force sensing systems in accordance with many embodiments of the invention can use low-power guarding lasers. Non-contact force sensing systems in accordance with many embodiments of the invention can deploy high installation/vantage locations, e.g. ceilings, to enhance safety.

### Laser Powers and Colors

Non-contact force sensing systems in accordance with many embodiments of the invention can be used and tested on different laser power levels (e.g., 10, 20, 30, 50 mW) and colors (e.g., green, red, among others). Non-contact force sensing systems in accordance with many embodiments of the invention can use a green laser (visible) for ease of development and debug. In many embodiments in real-world applications, invisible infrared lasers can be used for minimizing intrusiveness.

### Types of Cameras

Non-contact force sensing systems in accordance with many embodiments of the invention can use different cameras including e.g., the IDS Imaging U3-3060CP, the GS3-U3-32S4M-C Grasshopper, ELP 5.0 megapixel and 2.0 megapixel USB Camera, among many other types of cameras as appropriate to the requirements of specific applications. Non-contact force sensing systems in accordance with many embodiments of the invention can use different framerates, including high camera framerate which can be an important factor in capturing clearer speckle motions that can be easier to track. Non-contact force sensing systems in accordance with many embodiments of the invention can use low-framerate cameras (which often are low-cost) and can track slow applications of force. To detect sudden applications of force, non-contact force sensing systems in accordance with many embodiments of the invention can use blur detection for certain cameras, including low-speed cameras. Non-contact force sensing systems in accordance with many embodiments of the invention can, if blur detection is used, detect the presence of force as it may not be able to track velocity and integrate it to get indicators for force. However, there can still be a rich set of use cases for it such as segmenting touch (detecting touch vs. no touch) on everyday surfaces, for on-body interactions.

### Increase Dynamic Range and Resolution

Non-contact force sensing systems in accordance with many embodiments of the invention can be optimized for 1) extreme large forces (e.g., car parking on the driveway) and/or 2) high sensing resolution (e.g., coin on the table) as appropriate to the requirements of specific applications.

Non-contact force sensing systems in accordance with many embodiments of the invention can provide better performance (e.g., faster speed, smaller pixel size, among various other properties) and force meters that can provide more fine-grain data.

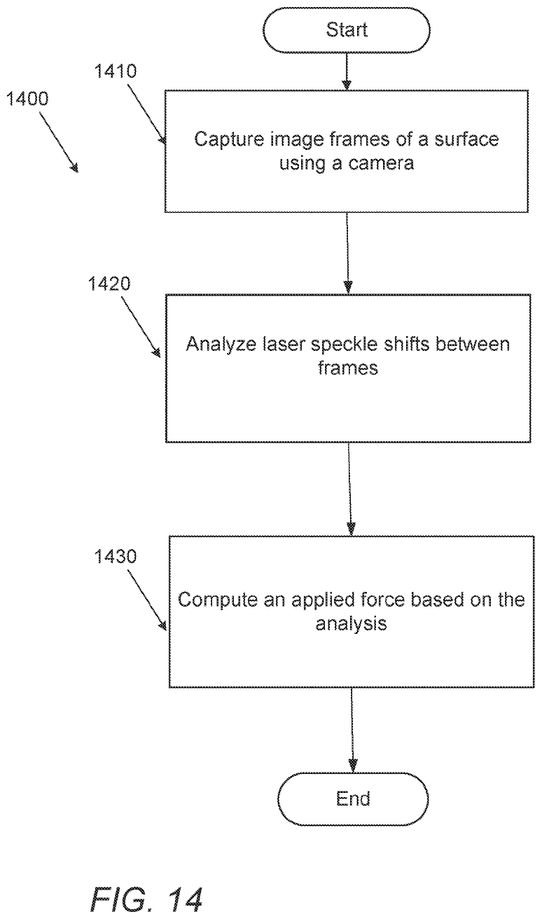

An example of a process for non-contact force sensing in accordance with an embodiment of the invention is illustrated in FIG. 14. Process 1400 captures (1410) images of a surface using a camera. In a variety of embodiments, a process can capture images using a camera that captures frames of a surface.

Process 1400 analyzes (1420) the captured images. In many embodiments, the process can calculate distance of laser speckle shifts between adjacent frames as a laser speckle velocity (LSV), where the laser speckle shifts define a speckle motion.

Process 1400 computes (1430) an applied force based on the analysis. In many embodiments can compute an integral of the laser speckle velocity (ILSV) as an indicator signal and can calculi an applied force f using the ILSV. The process can calculate the applied force f based on linearly correlating the speckle motion δI with the force f. Certain embodiments can calculate the applied force f based on a distance D from surface to the camera.

In several embodiments, the process can calculate the applied force based on a second moment of area

$$I = \frac{{wh}^{3}}{12} ,$$

where w and h are the width and thickness of a plate material, and the speckle motion δI is proportional to the inverse of a cube of thickness h.

In many embodiments, the process can determine a stiffness of a surface based on the speckle motion.

While specific processes for non-contact force sensing are described above, any of a variety of processes can be utilized for non-contact force sensing as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

An example of a system that executes instructions to perform processes that provide non-contact force sensing in accordance with various embodiments of the invention is illustrated in FIG. 14. Non-contact force sensing systems in accordance with many embodiments of the invention can include (but are not limited to) one or more of mobile devices, and/or computers. System 1500 include a camera 1505, processor 1515, network interface 1510, and memory 1520. One skilled in the art will recognize that a non-contact force sensing system may exclude certain components and/or include other components that are omitted for brevity without departing from this invention.

The camera 1505 can include (but is not limited to) at least one camera that can capture at least one image and/or video, including RGB images, depth camera, infrared cameras, among many other types of cameras as appropriate to the requirements of specific applications.

The processor 405 can include (but is not limited to) a processor, microprocessor, controller, or a combination of processors, microprocessor, and/or controllers that performs instructions stored in the memory 420 to manipulate data stored in the memory. Processor instructions can configure the processor 405 to perform processes in accordance with certain embodiments of the invention.

Peripherals 1520 can include any of a variety of components for capturing data, such as (but not limited to) cameras, displays, and/or sensors. In a variety of embodiments, peripherals can be used to gather inputs and/or provide outputs. System 1500 can utilize network interface 1510 to transmit and receive data over a network based upon the instructions performed by processor 1515. Camera and/or peripherals and/or network interfaces in accordance with many embodiments of the invention can be used to gather inputs that can be used to tokenize transactions.

Memory 1520 includes a force sensing application 425. Force sensing applications in accordance with several embodiments of the invention can be used to sense an applied force based on image analysis.

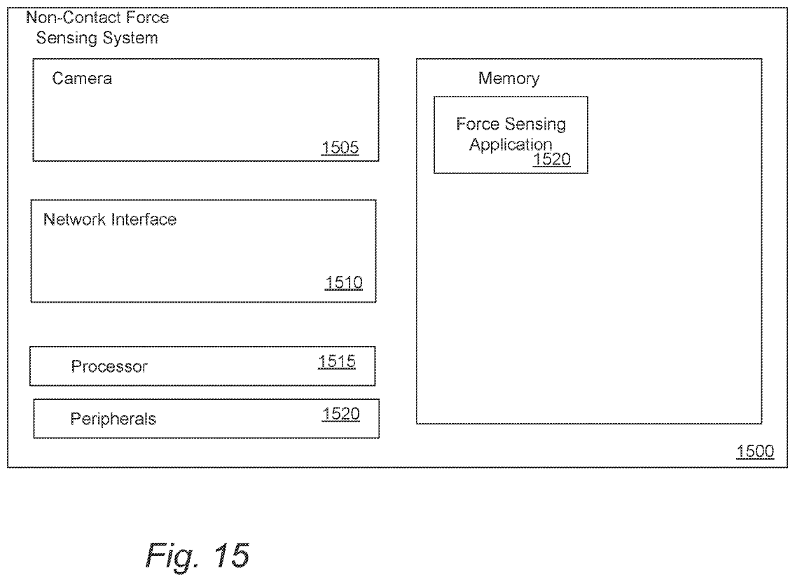

Although a specific example of a non-contact force sensing system 1500 is illustrated in FIG. 15, any of a variety of non-contact force sensing systems can be utilized to detect force similar to those described herein as appropriate to the requirements of specific applications in accordance with embodiments of the invention.

Although specific implementations for non-contact force sensing systems are discussed above with respect to FIGS. 1-15, any of a variety of implementations utilizing the above discussed techniques can be utilized for non-contact force sensing systems in accordance with embodiments of the invention. While the above description contains many specific embodiments of the invention, these should not be construed as limitations on the scope of the invention, but rather as an example of one embodiment thereof. It is therefore to be understood that the present invention may be practice otherwise than specifically described, without departing from the scope and spirit of the present invention. Thus, embodiments of the present invention should be considered in all respects as illustrative and not restrictive.

What is claimed is:

1. A non-contact force sensing system, comprising:
a laser source that illuminates a surface with a laser;
a camera that captures video comprising a plurality of images of the surface;
a set of one or more processors;
a non-transitory machine readable medium containing processor instructions for non-contact force sensing, where execution of the instructions by the set of processors causes the set of processors to perform a process that comprises:
analyzing the plurality of images of the video to determine laser speckle motion due to surface deformations to the surface; and
determining an applied force on the surface based on the analysis.

2. The non-contact force sensing system of claim 1, wherein the laser source is in at least one mode selected from the group consisting of a diffused mode and a focused mode, wherein in the diffused mode, the laser source is diverged and expanded with multiple concave lens and an optical diffusing glass that can spread light over a surface, wherein in the focused mode, the laser remains as a bright dot with concentrated energy.

3. The non-contact force sensing system of claim 1, where execution of the instructions by the set of processors causes the set of processors to perform a process that further comprises analyzing the plurality of images of the video to estimate flow displacement across fixed timeframes to obtain a correlated metric to flow velocity, wherein the flow displacement is converted to the flow velocity through a framerate-dependent scale factor.

4. The non-contact force sensing system of claim 1, where execution of the instructions by the set of processors causes the set of processors to perform a process that further comprises:
calculating distance of laser speckle shifts between adjacent images of the plurality of image as a laser speckle velocity (LSV), wherein the laser speckle shifts define a speckle motion;
compute an integral of LSV (ILSV) as an indicator signal; and
calculate an applied force f using the ILSV.

5. The non-contact force sensing system of claim 1, where execution of the instructions by the set of processors causes the set of processors to perform a process that further comprises: calculating an applied force f based on linearly correlating a speckle motion δI with the force f.

6. The non-contact force sensing system of claim 1, where execution of the instructions by the set of processors causes the set of processors to perform a process that further comprises: calculating an applied force f based on a distance D from the surface to the camera.

7. The non-contact force sensing system of claim 1, where execution of the instructions by the set of processors causes the set of processors to perform a process that further comprises: calculating an applied force based on a second moment of area
$$I = \frac{{wh}^{3}}{12} ,$$
where w and h are a width and thickness of a plate material, and the speckle motion δI is proportional to an inverse of a cube of thickness h.

8. The non-contact force sensing system of claim 1, where execution of the instructions by the set of processors causes the set of processors to perform a process that further comprises: determining a stiffness of the surface based on the laser speckle motion.

9. The non-contact force sensing system of claim 1, wherein the surface is a type of surface from a plurality of different types of surfaces such that for a particular surface with a particular physical configuration, there is a mapping that is learned from an estimated average speckle velocity to an instantaneous applied surface pressure, where the speckle velocity estimate is an average projected length of vectors within an image frame towards an estimated center, for a given time frame that provides a signed measure for velocity, wherein a cumulative sum of the estimated velocity over time is directly related to an instantaneous applied force.

10. A method of non-contact force sensing, comprising:
illuminating a surface using a laser source;
capturing video comprising a plurality of images using a camera;
analyzing the plurality of images of the video to determine laser speckle motion due to surface deformations to the surface; and
determining an applied force on the surface based on the analysis.

11. The method of claim 10, wherein the laser source is in at least one mode selected from the group consisting of a diffused mode and a focused mode, wherein in the diffused mode, the laser source is diverged and expanded with multiple concave lens and an optical diffusing glass that can spread light over a whole surface, wherein in the focused mode, the laser remains as a bright dot with concentrated energy.

12. The method of claim 10, further comprising analyzing the plurality of images of the video to estimate flow displacement across fixed timeframes to obtain a correlated metric to flow velocity, wherein the flow displacement is converted to the flow velocity through a framerate-dependent scale factor.

13. The method of claim 10, further comprising:
calculating distance of laser speckle shifts between adjacent images of the plurality of image as a laser speckle velocity (LSV), wherein the laser speckle shifts define a speckle motion;
compute an integral of LSV (ILSV) as an indicator signal; and
calculate an applied force f using the ILSV.

14. The method of claim 10, further comprising: calculating an applied force f based on linearly correlating a speckle motion δI with the force f.

15. The method of claim 10, further comprising: calculating an applied force f based on a distance D from the surface to the camera.

16. The method of claim 10, further comprising: calculating an applied force based on a second moment of area
$$I = \frac{{wh}^{3}}{12} ,$$
where w and h are a width and thickness of a plate material, and the speckle motion δI is proportional to an inverse of a cube of thickness h.

17. The method of claim 10, further comprising: determining a stiffness of the surface based on the laser speckle motion.

18. The method of claim 10, wherein the surface is a type of surface from a plurality of different types of surfaces such that for a particular surface with a particular physical configuration, there is a mapping that is learned from an estimated average speckle velocity to an instantaneous applied surface pressure, where the speckle velocity estimate is an average projected length of vectors within an image frame towards an estimated center, for a given time frame that provides a signed measure for velocity, wherein a cumulative sum of the estimated velocity over time is directly related to an instantaneous applied force.

19. A non-transitory machine readable medium containing processor instructions for non-contact force sensing, where execution of the instructions by a processor causes the processor to perform a process that comprises:
illuminating a surface using a laser source;
capturing video comprising a plurality of images using a camera;
analyzing the plurality of images of the video to determine laser speckle motion due to surface deformations to the surface; and
determining an applied force on the surface based on the analysis.

20. The non-transitory machine readable medium of claim 19, where execution of the instructions by the processor causes the processor to perform the process that further comprises:
calculating distance of laser speckle shifts between adjacent images of the plurality of image as a laser speckle velocity (LSV), wherein the laser speckle shifts define a speckle motion;
compute an integral of LSV (ILSV) as an indicator signal; and
calculate an applied force f using the ILSV.
